(19) United States
(12) Patent Application Publication
(10) Pub. No.: US 2025/0244012 A1
(43) Pub. Date: Jul. 31, 2025

(54) COMBUSTION SYSTEM AND PREDICTION DEVICE

(71) Applicant: IHI Corporation, Tokyo (JP)

(72) Inventors: Hirotaka KAWABE, Tokyo (JP); Kiminori SATO, Tokyo (JP)

(21) Appl. No.: 19/185,270

(22) Filed: Apr. 22, 2025

Related U.S. Application Data
(63) Continuation of application No. PCT/JP2023/038712, filed on Oct. 26, 2023.

(30) Foreign Application Priority Data
Feb. 22, 2023 (JP) 2023-026008

(51) Int. Cl. F23N 5/00; F23K 3/00; G05B 15/02

(52) U.S. Cl. CPC F23N 5/003; F23K 3/00; G05B 15/02; F23K 2201/103; F23K 2201/20; F23K 2201/501; F23N 2225/10; F23N 2237/08; F23N 2239/02; F23N 2900/05001; F23N 2900/05003

(57) ABSTRACT

A combustion system including a fuel storage stores solid fuel, a supply device connected to the fuel storage, a combustion device combusts supplied solid fuel, and a prediction device for predicting a switching time for types of solid fuel supplied from the fuel storage to the combustion device via the supply device. The prediction device comprises at least one processor configured to acquire a level of solid fuel stored in the fuel storage, predict, as the switching time, a future time when a level obtained by extrapolating time-dependent change in decrease in the level of the solid fuel reaches a threshold value, and display the switching time on a display device.

### CROSS-REFERENCE TO RELATED APPLICATIONS

This application is a continuation application of PCT Application No. PCT/JP2023/038712, filed on Oct. 26, 2023, which claims the benefit of priority from Japanese Patent Application No. 2023-026008, filed on Feb. 22, 2023. The entire contents of which are incorporated herein by reference.

### BACKGROUND

There has been a known combustion device that continuously switches types of solid fuels and combusts the solid fuels.

For example, Japanese Unexamined Patent Publication No. 2015-25582 describes a combustion device that continuously switches biomass fuel and coal fuel. The invention described in Japanese Unexamined Patent Publication No. 2015-25582 changes operating conditions of a fuel pulverizer according to a mixture ratio of biomass fuel and coal fuel. The invention described in Japanese Unexamined Patent Publication No. 2015-25582 requires that the bulk density of each solid fuel be clearly distinguishable.

When types of solid fuels are switched, operation conditions of the combustion device change. For example, when low-quality solid fuel or new solid fuel begins to combust, the operation conditions, such as a temperature inside the combustion device, change.

Therefore, it is necessary to closely monitor the operation conditions of the combustion device before and after a time when the types of solid fuels are switched. However, since there is a time lag between storing and combusting solid fuel, it has been difficult to predict the time when the types of solid fuels are switched.

The disclosure describes technology capable of predicting the time when the types of solid fuels supplied to the combustion device are switched.

### SUMMARY

A prediction device according to an aspect of the disclosure predicts a switching time for types of solid fuels supplied from a storage unit to a combustion device via a supply device. The prediction device includes an acquisition unit configured to acquire a level of solid fuels stored in the storage unit, and a prediction unit configured to predict, as the switching time, a future time when a level obtained by extrapolating time-dependent change in decrease in the level of the solid fuels reaches a threshold value.

### BRIEF DESCRIPTION OF THE DRAWINGS

FIG. 1 is a block diagram illustrating a configuration of a prediction system 1 according to an example.

FIG. 2 is a graph illustrating an example of time-dependent change in a level of solid fuels.

FIG. 3 is a graph illustrating an example of time-dependent change in temperature of gas.

FIG. 4 is a graph illustrating an example of time-dependent change in concentration of a chemical substance.

FIG. 5 illustrates an example of a screen displaying time-dependent change in a level of solid fuels and a switching time.

FIG. 6 is a flowchart illustrating an example of an operation of a prediction device.

FIG. 7 is a diagram illustrating an example of a hardware configuration related to the prediction system.

### DETAILED DESCRIPTION

A prediction device according to an aspect of the disclosure predicts a switching time for types of solid fuels supplied from a storage unit to a combustion device via a supply device. The prediction device includes an acquisition unit that acquires a level of solid fuels stored in the storage unit, and a prediction unit that predicts, as the switching time, a future time when a level obtained by extrapolating time-dependent change in decrease in the level of the solid fuels reaches a threshold value.

In the prediction device, the switching time for the types of solid fuels is predicted based on a level obtained by extrapolating a decrease in level of the solid fuels and a threshold value. Here, in the storage unit, solid fuel is added and removed, and thus the level of the solid fuels fluctuates. In the prediction device of the disclosure, the level of the solid fuels is complemented by the level obtained by extrapolating a decrease in level of the solid fuels. In this way, for example, even when various types of solid fuel are added to the storage unit, it may be possible to predict a pace of a decrease in level of the solid fuels. As a result, prediction accuracy of the switching time is improved.

The acquisition unit may acquire a temperature of gas supplied to the supply device. The prediction device may further include a determination unit that determines a threshold value based on a time when a tendency for the temperature of the gas changes and a level obtained by extrapolating time-dependent change in decrease in the level of the solid fuels. According to this configuration, a relationship between change in the tendency for the temperature of the gas and the level obtained by extrapolating a decrease in level of the solid fuels is reflected in determination of the threshold value. In this way, accuracy of the threshold value for specifying the switching time is improved. As a result, prediction accuracy of the switching time is improved.

The acquisition unit may acquire concentration of a chemical substance generated by combustion of solid fuel. The prediction device may further include a determination unit that determines a threshold value based on a time when a tendency of the concentration of the chemical substance changes and a level obtained by extrapolating time-dependent change in decrease in the level of the solid fuels. According to this configuration, a relationship between change in the tendency of the concentration of the chemical substance and the level obtained by extrapolating a decrease in the level of the solid fuels is reflected in determination of the threshold value. In this way, accuracy of the threshold value for specifying the switching time is improved. As a result, a time when the types of solid fuels supplied to the combustion device are switched may be predicted with high accuracy.

The prediction device may further include an output unit that displays the switching time on a display device. In this way, convenience of a user, an operator, etc. using the switching time is improved.

The acquisition unit may acquire the level of the solid fuels for each of a plurality of units, each of which includes a storage unit and a supply device. The prediction unit may predict, as a switching time, a future time when the level obtained by extrapolating time-dependent change in decrease in the level of the solid fuels reaches a threshold value for each of the plurality of units. According to such a configuration, the switching time is predicted for each of the plurality of units. In this way, it may be possible to improve prediction accuracy of the switching time in the plurality of units. In addition, it may be possible to reduce the cost of monitoring the plurality of units.

Hereinafter, examples for implementing the disclosure will be described in detail with reference to the accompanying drawings. In the description of the drawings, the same elements are given the same reference numerals and duplicated description will be omitted.

A prediction system according to the disclosure is applied to, for example, a thermal power generation system. The thermal power generation system stores solid fuel. Examples of the solid fuel may include coal or biomass fuel. The thermal power generation system dries and pulverizes solid fuel. The thermal power generation system supplies the pulverized solid fuel to a combustion device such as a boiler and combusts the pulverized solid fuel. The combustion device supplies generated steam to a steam turbine. The steam is used to generate electricity. The prediction system predicts the switching time for the types of solid fuels supplied to the combustion device.

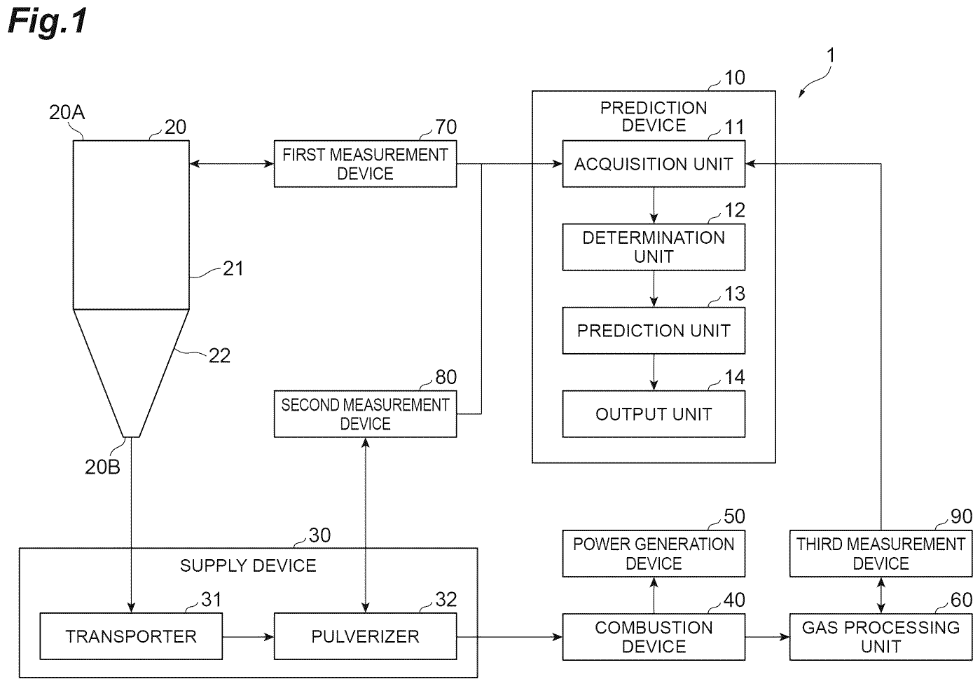

FIG. 1 is a block diagram illustrating a configuration of a prediction system 1 according to an example. The prediction system 1 includes a prediction device 10, a storage unit 20, a supply device 30, a combustion device 40, a power generation device 50, a gas processing unit 60, a first measurement device 70, a second measurement device 80, and a third measurement device 90. The prediction system 1 may include a plurality of units, each of which includes the storage unit 20 and the supply device 30.

The storage unit 20 is a cylindrical container for storing solid fuel. One end 20A of the storage unit 20 is an input port for the solid fuel. The other end 20B of the storage unit 20 is an output port for the solid fuel. A caliber at the one end 20A of the storage unit 20 is larger than a caliber at the other end 20B of the storage unit. For example, the storage unit 20 has a cylindrical tube portion 21 and a conical tapered portion 22 that tapers toward the other end 20B of the storage unit 20.

Solid fuel is added from the one end 20A of the storage unit 20 and is piled up inside the storage unit 20. Hereinafter, a height of the solid fuel piled up inside the storage unit 20 is referred to as a “level of solid fuel”. A different type of solid fuel from that of the solid fuel previously stored therein may be added to the storage unit 20. As a result, different types of solid fuels are piled up in the storage unit 20. When solid fuel is added to the storage unit 20, a level of the solid fuel increases. The stored solid fuel is removed from the other end 20B of the storage unit 20. The other end of the storage unit 20 is connected to the supply device 30. When solid fuel is removed from the storage unit 20, the level of the solid fuel decreases. When there is no addition of solid fuel to the storage unit 20 or no removal of solid fuel from the storage unit 20, the level of the solid fuel does not change.

The supply device 30 supplies the solid fuel stored in the storage unit 20 to the combustion device 40. The supply device 30 includes a transporter 31 and a pulverizer 32.

The transporter 31 receives solid fuel from the other end 20B of the storage unit 20, and supplies the solid fuel to the pulverizer 32. The transporter 31 is, for example, a gravimetric coal feeder. The transporter 31 detects the weight of the solid fuel using a load cell, etc. The transporter 31 transports a predetermined amount of solid fuel using a belt conveyor, etc., and supplies the solid fuel to the pulverizer 32.

The pulverizer 32 dries and pulverizes the solid fuel. The pulverizer 32 is, for example, a coal pulverizer. An air inlet or an inlet of the pulverizer 32 is supplied with gas, for example, hot air. The pulverizer 32 dries the solid fuel using the supplied gas. The pulverizer 32 pulverizes the dried solid fuel. The dried and pulverized solid fuel is blown up by the supplied gas and carried to an exhaust outlet or an outlet of the pulverizer 32. The pulverizer 32 supplies the solid fuel to a combustion device 40 using the supplied gas.

During a drying and pulverizing process of the pulverizer 32, a property and state of solid fuel affects a temperature of gas inside the pulverizer 32. For example, humidity, etc. of the solid fuel fluctuates depending on the quality of the solid fuel, the season or weather, etc. In the pulverizer 32, the temperature of the gas supplied to the pulverizer 32 is controlled so that fluctuation in the temperature of the gas at the exhaust outlet or outlet of the pulverizer 32 is suppressed.

The combustion device 40 combusts supplied solid fuel. The combustion device 40 is, for example, a boiler that combusts the solid fuel to generate steam. The combustion device 40 supplies the steam to the power generation device 50. In the combustion device 40, exhaust gas is generated by combustion of the solid fuel. The combustion device 40 sends the exhaust gas to the gas processing unit 60.

The power generation device 50 generates electric power using steam. For example, the power generation device 50 generates electric power using rotational energy of the steam turbine receiving the steam.

The gas processing unit 60 processes the exhaust gas. The gas processing unit 60 processes the exhaust gas using, for example, a flue gas denitrification device, a dust collector, a flue gas desulfurization device, etc. The exhaust gas is discharged into the air from a chimney.

The first measurement device 70 measures the level of the solid fuels stored in the storage unit 20. The first measurement device 70 is, for example, an interface meter. The first measurement device 70 transmits the measured level of the solid fuels to the prediction device 10.

The second measurement device 80 measures a temperature of gas supplied to the supply device 30. More specifically, the second measurement device 80 measures a temperature of gas supplied to the pulverizer 32 at the air inlet of the pulverizer 32. The second measurement device 80 is, for example, a thermometer. The second measurement device 80 transmits the measured temperature of the gas to the prediction device 10.

The third measurement device 90 measures concentration of a chemical substance generated by combustion of solid fuel. The third measurement device 90 is, for example, a concentration meter. For example, the third measurement device 90 measures concentration of a chemical substance in exhaust gas discharged from the chimney of the gas processing unit 60. Examples of the chemical substance include sulfur oxides (SOx), nitrogen oxides (NOx), and carbon monoxide (CO). The third measurement device 90 transmits the measured concentration of the chemical substance to the prediction device 10.

The prediction device 10 predicts a switching time for types of solid fuels supplied from the storage unit 20 to the combustion device 40 via the supply device 30. A type and configuration of the prediction device 10 are not limited. For example, the prediction device 10 may be a personal computer, a highly functional mobile phone (smartphone), a tablet terminal, or a wearable terminal. The prediction device 10 includes an acquisition unit 11, a determination unit 12, a prediction unit 13, and an output unit 14 as functional elements.

The acquisition unit 11 acquires the level of the solid fuels stored in the storage unit 20. For example, the acquisition unit 11 receives the level of the solid fuels from the first measurement device 70. The acquisition unit 11 acquires a temperature of gas supplied to the supply device 30. For example, the acquisition unit 11 receives the temperature of the gas from the second measurement device 80. The acquisition unit 11 acquires concentration of a chemical substance generated by combustion of the solid fuels. For example, the acquisition unit 11 receives the concentration of the chemical substance from the third measurement device 90.

The determination unit 12 determines a threshold value related to the level of the solid fuels. In this example, when the level of the solid fuels decreases and reaches the threshold value, it is determined that the types of solid fuels supplied to the combustion device 40 are switched. The determination unit 12 determines the threshold value using at least one of the level obtained by extrapolating time-dependent change in decrease in the level of the solid fuels, the temperature of the gas, and the concentration of the chemical substance. The determination unit 12 may store the predetermined threshold value in a predetermined storage device.

The prediction unit 13 predicts the switching time for the types of solid fuels. For example, the prediction unit 13 predicts, as the switching time, a future time when the level obtained by extrapolating time-dependent change in decrease in the level of the solid fuels reaches the threshold value.

The output unit 14 outputs the switching time. For example, the output unit 14 displays the switching time on the display device of the prediction device 10 or on an external display device.

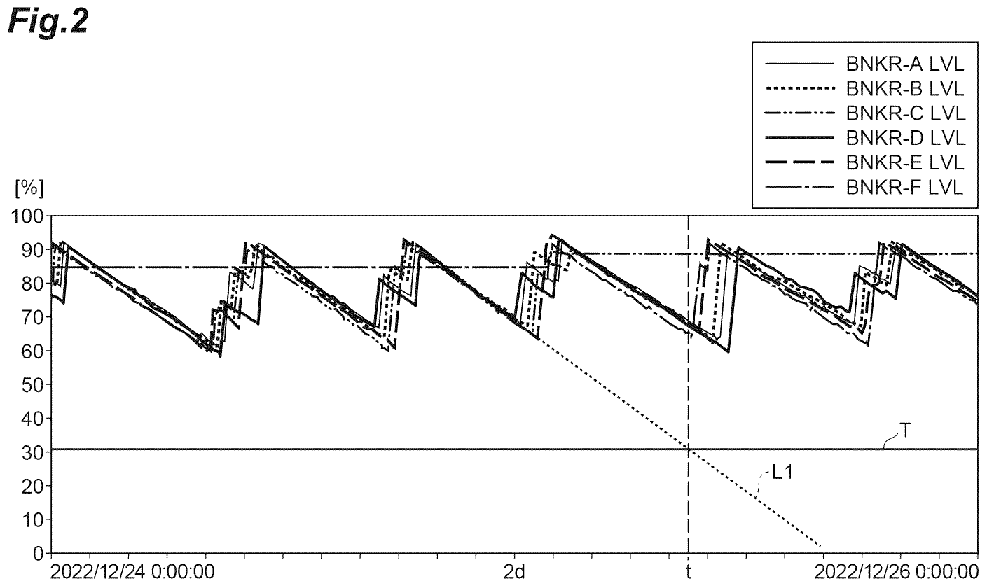

An example of processing of the determination unit 12 will be described with reference to FIGS. 2 to 4. In FIGS. 2 to 4, the prediction system 1 will be described as having a plurality of units A, B, C, D, E, and F, each of which includes the storage unit 20 and the supply device 30. Each of the plurality of units A, B, C, D, E, and F includes a bunker as the storage unit 20. Each of the plurality of units A, B, C, D, E, and F includes a coal pulverizer as the pulverizer 32.

FIG. 2 is a graph illustrating an example of time-dependent change in a level of solid fuels. In FIG. 2, a horizontal axis represents time, and a vertical axis represents of a level [%] of solid fuels in the storage unit 20. “BNKR-A LVL” indicates a level of solid fuels in a bunker of a unit A. “BNKR-B LVL” indicates a level of solid fuels in a bunker of a unit B. “BNKR-C LVL” indicates a level of solid fuels in a bunker of a unit C. “BNKR-D LVL” indicates a level of solid fuels in a bunker of a unit D. “BNKR-E LVL” indicates a level of solid fuels in a bunker of a unit E. “BNKR-F LVL” indicates a level of solid fuels in a bunker of a unit F. FIG. 2 illustrates a level L obtained by extrapolating a decrease in level of the solid fuels in the bunker of the unit D.

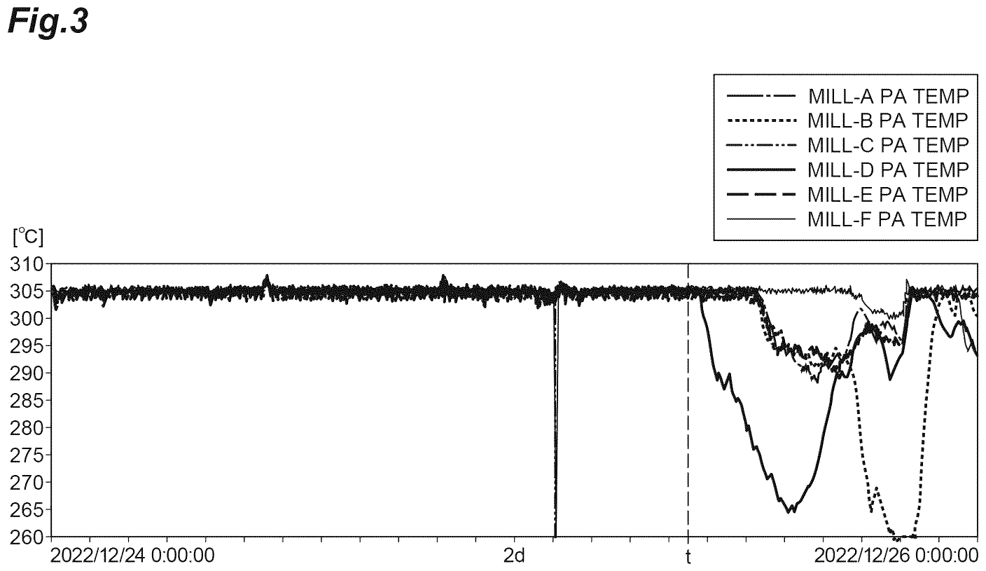

FIG. 3 is a graph illustrating an example of time-dependent change in temperature of gas. In FIG. 3, a horizontal axis represents time, and a vertical axis represents temperature [° C.]. “MILL-A PA TEMP” indicates a temperature of gas supplied to a coal pulverizer of the unit A. “MILL-B PA TEMP” indicates a temperature of gas supplied to a coal pulverizer of the unit B. “MILL-C PA TEMP” indicates a temperature of gas supplied to a coal pulverizer of the unit C. “MILL-D PA TEMP” indicates a temperature of gas supplied to a coal pulverizer of the unit D. “MILL-E PA TEMP” indicates a temperature of gas supplied to a coal pulverizer of the unit E. “MILL-F PA TEMP” indicates a temperature of gas supplied to a coal pulverizer of the unit F.

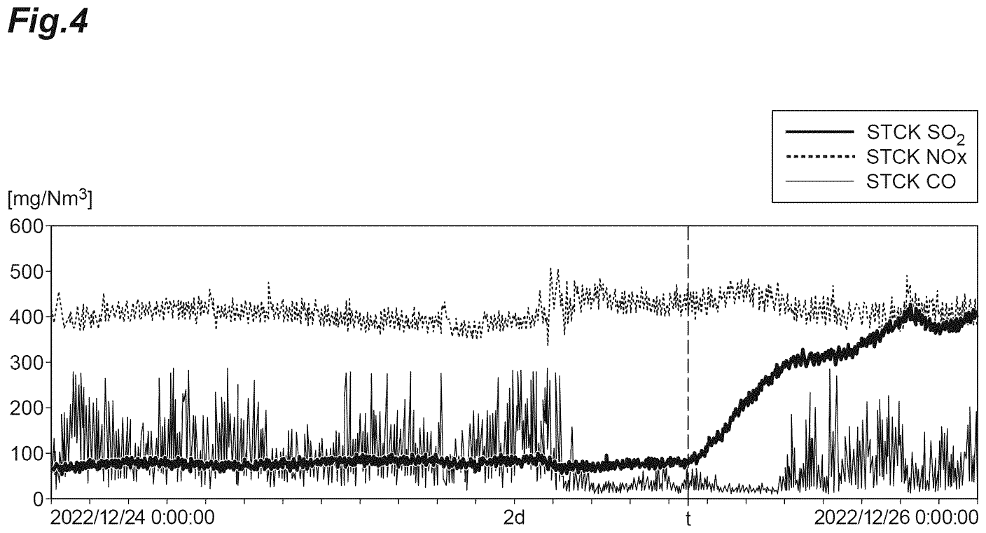

FIG. 4 is a graph illustrating an example of time-dependent change in concentration of a chemical substance. In FIG. 4, a horizontal axis represents time, and a vertical axis represents concentration [mg/Nm³]. FIG. 4 illustrates time-dependent changes in concentrations of sulfur dioxide (SO₂) as an example of SOx, NOx, and CO. “STCK SO₂” indicates the concentration of SO₂. “STCK NOx” indicates the concentration of NOx. “STCK CO” indicates the concentration of CO.

In one example, the determination unit 12 detects a time when a tendency for a temperature of gas changes. For example, the determination unit 12 detects a time when time-dependent change of the temperature of the gas changes from a constant to an increasing tendency or a decreasing tendency. Before time t illustrated in FIG. 3, the temperature of the gas supplied to the coal pulverizer of the unit D is approximately constant. After time t, the temperature of the gas supplied to the coal pulverizer of the unit D changes to a decreasing tendency. The determination unit 12 detects time t when the tendency for time-dependent change of the temperature of the gas changes for the unit D. For example, the determination unit 12 may detect time t based on the amount of fluctuation in the temperature of the gas within a predetermined time, etc.

The determination unit 12 may determine the threshold value based on time t when the tendency for the temperature of the gas changes and the level obtained by extrapolating time-dependent change in decrease in the level of the solid fuels. For example, the determination unit 12 may determine an extrapolated level as the threshold value at time t. As an example, an extrapolated level L1 reaches a level of 30% at time t illustrated in FIG. 2. The determination unit 12 determines the level of 30% as a threshold value T.

As another example, the determination unit 12 detects a time when a tendency for the concentration of the chemical substance changes. For example, the determination unit 12 detects a time when time-dependent change of the concentration of the chemical substance changes from a constant to an increasing tendency or a decreasing tendency. Before time t illustrated in FIG. 4, the concentration of SO₂ is approximately constant. After time t, the concentration of SO₂ changes to an increasing tendency. The determination unit 12 detects time t when a tendency for time-dependent change of the concentration of SO₂ changes. For example, the determination unit 12 may detect time t based on the amount of fluctuation in the concentration of SO₂ within a predetermined time.

The determination unit 12 may determine a threshold value based on time t when the tendency for the concentration of the chemical substance changes and the level obtained by extrapolating time-dependent change in decrease in the level of the solid fuels. For example, the determination unit 12 may determine an extrapolated level as the threshold value at time t. As an example, an extrapolated level L1 reaches a level of 30% at time t illustrated in FIG. 2. The determination unit 12 determines the level of 30% as a threshold value T.

The determination unit 12 may detect time t based on both the tendency for the temperature of the gas and the tendency for the concentration of the chemical substance. For example, the determination unit 12 may detect time t when the time-dependent change for the temperature of the gas and the time-dependent change for the concentration of the chemical substance change from constants to increasing tendencies or decreasing tendencies. The determination unit 12 may determine a threshold value based on detect time t when the tendency for the temperature of the gas and the tendency for the concentration of the chemical substance change and the level obtained by extrapolating a decrease in level of the solid fuels. The determination unit 12 may calculate an extrapolated level for each unit. The threshold value T may be different for each unit.

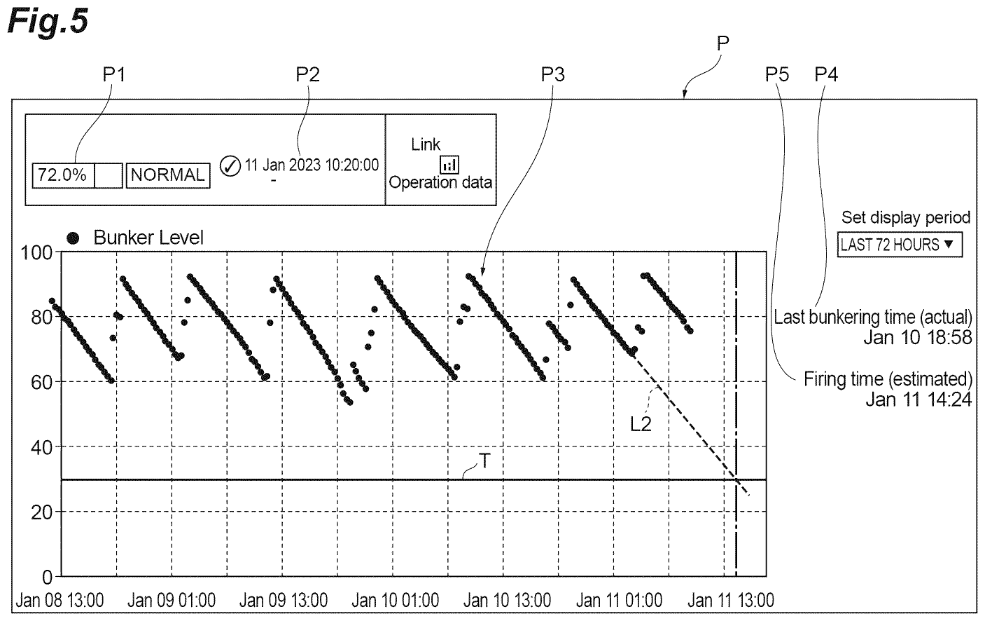

An example of processing of the prediction unit 13 and the output unit 14 will be described with reference to FIG. 5. FIG. 5 illustrates an example of a screen displaying time-dependent change in a level of solid fuels and a switching time. The output unit 14 displays a screen P, for example, on the display device of the prediction device 10 or on the external display device. The screen P includes information provided to a user or an operator of the prediction system 1, etc. For example, the screen P displays a level P1, a current time P2, a graph P3, a final adding time P4, and a switching time P5.

The level P1 is a field that displays a current level [%] of solid fuels. The current time P2 is a field that displays a current time. “11 Jan. 2023 10:20:00” is displayed in the current time P2. The graph P3 is a graph indicating time-dependent change in the level of the solid fuels. In the graph P3, a horizontal axis represents time, and a vertical axis represents the level [%] of the solid fuels in the storage unit 20. The final adding time P4 is a field that displays a time when solid fuel is added to the storage unit 20. “January 10 18:58” is displayed in the final adding time P4. The switching time P5 is a field that displays a predicted switching time. “January 11 14:24” is displayed in the switching time P5.

The prediction unit 13 calculates a level L2 obtained by extrapolating time-dependent change in decrease in the level of the solid fuels using a level of solid fuels after the final adding time P4. For example, the prediction unit 13 calculates the extrapolated level L2 using the decrease in the level of the solid fuels after “January 10 18:58”. The extrapolated level L2 does not have to be or may be displayed on the screen P. The prediction unit 13 predicts a future time when the extrapolated level L2 reaches the threshold value T as a switching time. The prediction unit 13 predicts, as the switching time, “January 11 14:24”, which is a future time when the extrapolated level L2 and a threshold value T2 intersect each other.

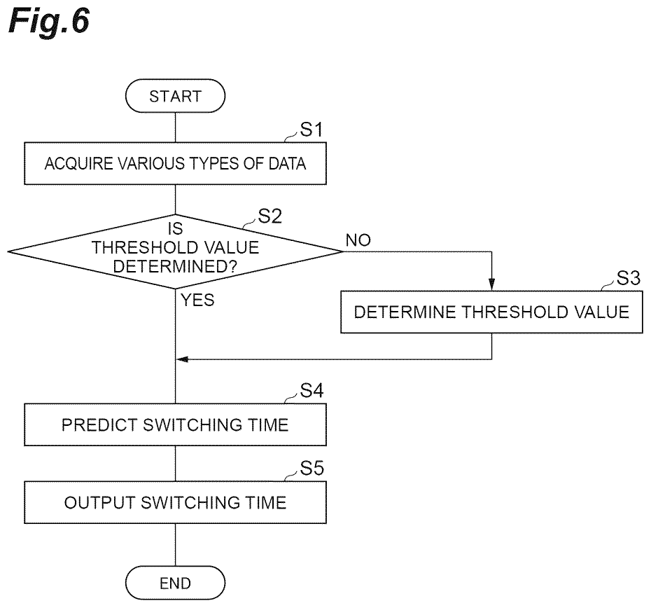

An example of an operation method of the prediction device 10 will be described with reference to FIG. 6. FIG. 6 is a flowchart illustrating an example of an operation of the prediction device 10.

In operation S1, the prediction device 10 acquires various types of data used for prediction of a switching time. For example, the acquisition unit 11 receives a level of solid fuels from the first measurement device 70. The acquisition unit 11 receives a temperature of gas from the second measurement device 80. The acquisition unit 11 receives concentration of a chemical substance from the third measurement device 90.

In operation S2, when a threshold value related to the level of the solid fuels has not been determined (operation S2: NO), the process proceeds to operation S3. When the threshold value related to the level of the solid fuels has been determined (operation S2: YES), the process proceeds to operation S4. For example, the prediction device 10 may perform determination in operation S2 depending on whether a predetermined threshold value is stored in a predetermined storage device.

In operation S3, the prediction device 10 determines the threshold value. For example, the determination unit 12 may determine the threshold value based on a time when time-dependent change in a temperature of gas changes to an increasing tendency or a decreasing tendency and the level of the solid fuels. The determination unit 12 may determine the threshold value based on a time when time-dependent change in concentration of a chemical substance changes to an increasing tendency or decreasing tendency and the level of the solid fuels. The determination unit 12 may determine the threshold value based on a time when the time-dependent change in the temperature of the gas and the time-dependent change in the concentration of the chemical substance change to increasing tendencies or decreasing tendencies and the level of the solid fuels.

In operation S4, the prediction device 10 predicts a switching time for types of solid fuels. For example, the prediction unit 13 predicts, as the switching time, a future time when the level obtained by extrapolating time-dependent change in decrease in the level of the solid fuels reaches the threshold value. In one example, the prediction unit 13 predicts, as the switching time, a future time when the extrapolated level L2 illustrated in FIG. 5 reaches the threshold value T.

In operation S5, the prediction device 10 outputs the switching time. For example, the output unit 14 displays the switching time on the display device of the prediction device 10 or on the external display device. In one example, the output unit 14 displays the screen P including the switching time P5 illustrated in FIG. 5 on the display device. Display of the screen P may prompt the user or the operator of the prediction system 1 to take appropriate measures. For example, the operator may focus on monitoring operation conditions of the combustion device 40 before and after the switching time. The operator may change control of the combustion device 40 before and after the switching time.

### [Hardware Configuration]

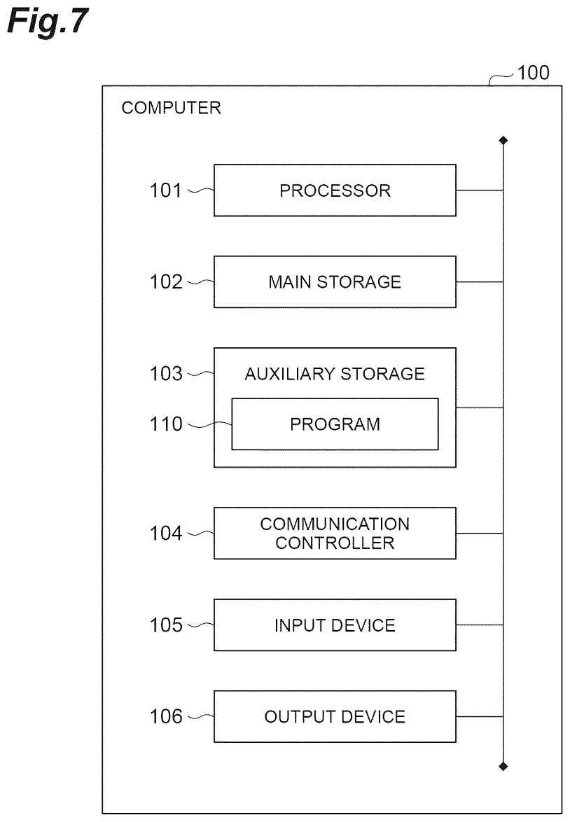

FIG. 7 is a diagram illustrating an example of a hardware configuration related to the prediction system 1. FIG. 7 illustrates a computer 100 functioning as the prediction device 10. The computer 100 has a CPU (Central Processing Unit) 101, a main storage 102, an auxiliary storage 103, a communication controller 104, an input device 105, and an output device 106. The prediction device 10 includes one or a plurality of computers 100, each of which includes these pieces of hardware and software such as a program.

When the prediction device 10 includes the plurality of computers 100, these computers 100 may be connected locally or via a communication network such as the Internet or an intranet. This connection logically constructs one prediction device 10.

The CPU 101 executes an operating system, an application program, etc. The main storage 102 includes a ROM (Read Only Memory) and a RAM (Random Access Memory). The auxiliary storage 103 is a storage medium including a hard disk, a flash memory, etc. The auxiliary storage 103 generally stores a larger amount of data than that of the main storage 102. The communication controller 104 includes a network card or a wireless communication module. At least a part of a communication function with respect to other devices in the prediction device 10 may be realized by the communication controller 104. The input device 105 includes a keyboard, a mouse, a touch panel, a microphone for voice input, etc. The output device 106 includes a display, a printer, etc.

The auxiliary storage 103 stores in advance a program 110 (prediction program) and data used for processing. The program 110 causes the computer 100 to execute each functional element of the prediction device 10. The program 110 causes, for example, processing related to the above-described prediction method to be executed in the computer 100. For example, the program 110 is loaded by the CPU 101 or the main storage 102, and causes at least one of the CPU 101, the main storage 102, the auxiliary storage 103, the communication controller 104, the input device 105, and the output device 106 to operate. For example, the program 110 reads and writes data in the main storage 102 and the auxiliary storage 103.

For example, the program 110 may be provided after being recorded on a tangible storage medium such as a CD-ROM, a DVD-ROM, or a semiconductor memory. The program 110 may be provided as a data signal via a communication network.

As described above, the prediction device 10 according to an aspect of the disclosure predicts a switching time for types of solid fuels supplied from the storage unit 20 to the combustion device 40 via the supply device 30. The prediction device 10 includes the acquisition unit 11 that acquires a level of solid fuels stored in the storage unit 20, and the prediction unit 13 that predicts, as the switching time, a future time when a level obtained by extrapolating time-dependent change in decrease in the level of the solid fuels reaches a threshold value.

In the prediction device 10, the switching time for the type of solid fuels is predicted by the level obtained by extrapolating the decrease in the level of the solid fuels and the threshold value. Here, in the storage unit 20, solid fuel is added and removed, and thus the level of the solid fuels fluctuates. In the prediction device 10 of the disclosure, the level of the solid fuels is complemented by the level obtained by extrapolating the decrease in the level of the solid fuels. In this way, for example, it may be possible to predict a pace of a decrease in the level of the solid fuels even when various types of solid fuels are added to the storage unit 20. As a result, prediction accuracy of the switching time is improved.

The acquisition unit 11 acquires a temperature of gas supplied to the supply device 30. The prediction device 10 further includes the determination unit 12 that determines a threshold value based on a time when a tendency for the temperature of the gas changes and the level obtained by extrapolating time-dependent change in decrease in the level of the solid fuels. According to such a configuration, a relationship between the change in the tendency for the temperature of the gas and the level obtained by extrapolating the decrease in the level of the solid fuels is reflected in determination of the threshold value. In this way, accuracy of the threshold value for specifying the switching time is improved. As a result, prediction accuracy of the switching time is improved.

The acquisition unit 11 acquires concentration of a chemical substance generated by combustion of solid fuel. The prediction device 10 further includes the determination unit 12 that determines a threshold value based on a time when a tendency for the concentration of the chemical substance changes and the level obtained by extrapolating time-dependent change in decrease in the level of the solid fuels. According to such a configuration, a relationship between the change in the tendency for the concentration of the chemical substance and the level obtained by extrapolating the decrease in the level of the solid fuels is reflected in determination of the threshold value. In this way, accuracy of the threshold value for specifying the switching time is improved. As a result, the time when the types of solid fuels supplied to the combustion device 40 are switched may be predicted with high accuracy.

The prediction device 10 further includes the output unit 14 that displays the switching time on the display device. In this way, convenience of the user, the operator, etc. using the switching time is improved.

The acquisition unit 11 acquires the level of the solid fuels for each of the plurality of units, each of which includes the storage unit 20 and the supply device 30. The prediction unit 13 predicts, as the switching time, a future time when the level obtained by extrapolating time-dependent change in decrease in the level of the solid fuels reaches a threshold value for each of the plurality of units. According to such a configuration, the switching time is predicted for each of the plurality of units. In this way, it may be possible to improve prediction accuracy of the switching time in the plurality of units. In addition, it may be possible to reduce the cost of monitoring the plurality of units.

### Modified Example

It is to be understood that not all aspects, advantages and features described herein may necessarily be achieved by, or included in, any one particular example. Indeed, having described and illustrated various examples herein, it should be apparent that other examples may be modified in arrangement and detail.

When comparing the magnitude of two numerical values, either of two criteria “greater than or equal to” and “greater than” may be used, or either of two criteria “less than or equal to” and “less than”.

### Supplementary Note

The disclosure is technology for predicting a time when types of solid fuels supplied to the combustion device are switched, and when this technology is used, it may be possible to operate the combustion device more efficiently. For this reason, the disclosure contributes to the following goals of the Sustainable Development Goals (SDGs) led by the United Nations.

Goal 7: “Ensure access to affordable, reliable, sustainable and modern energy for all people.”

The following is a summary of the disclosure.

[1]

A prediction device for predicting a switching time for types of solid fuels supplied from a storage unit to a combustion device via a supply device, the prediction device including:
an acquisition unit configured to acquire a level of solid fuels stored in the storage unit, and
a prediction unit configured to predict, as the switching time, a future time when a level obtained by extrapolating time-dependent change in decrease in the level of the solid fuels reaches a threshold value.

[2]

The prediction device according to [1], wherein
the acquisition unit acquires a temperature of gas supplied to the supply device, and
the prediction device further includes a determination unit configured to determine a threshold value based on a time when a tendency for the temperature of the gas changes and the level obtained by extrapolating time-dependent change in decrease in the level of the solid fuels.

[3]

The prediction device according to [1] or [2], wherein
the acquisition unit acquires concentration of a chemical substance generated by combustion of the solid fuels, and
the prediction device further includes a determination unit configured to determine a threshold value based on a time when a tendency for the concentration of the chemical substance changes and the level obtained by extrapolating time-dependent change in decrease in the level of the solid fuels.

[4]

The prediction device according to any one of [1] to [3], further including an output unit configured to display the switching time on a display device.

[5]

The prediction device according to any one of [1] to [4], wherein
the acquisition unit acquires the level of the solid fuels for each of a plurality of units each including the storage unit and the supply device, and
the prediction unit predicts, as the switching time, a future time when the level obtained by extrapolating time-dependent change in decrease in the level of the solid fuels reaches the threshold value for each of the plurality of units.

1. A combustion system comprising:
a fuel storage configured to store solid fuel;
a supply device connected to the fuel storage;
a combustion device configured to combust the solid fuel; and
a prediction device configured to predict a switching time of a type of the solid fuel supplied from the fuel storage to the combustion device via the supply device,
wherein the prediction device comprises at least one processor configured to:
acquire a level of the solid fuel stored in the fuel storage;
predict a future time as the switching time, the future time being a time when an extrapolated level for the switching time reaches a threshold value and the extrapolated level for the switching time being an extrapolated level of a time-dependent change in terms of a decrease in the level of the solid fuel when predicting the switching time; and
display the switching time on a display device.

2. The combustion system according to claim 1, wherein the processor is further configured to calculate the extrapolated level for the switching time using a level of the solid fuel after a latest adding time when the solid fuel was last added into the fuel storage.

3. The combustion system according to claim 1, further comprising an interface meter measuring the level of the solid fuel stored in the fuel storage and transmitting the measured level of the solid fuel to the prediction device.

4. The combustion system according to claim 1, wherein control of combustion of the solid fuel in the combustion device is altered according to the predicted switching time.

5. The combustion system according to claim 1, further comprising a thermometer measuring a temperature of gas supplied to the supply device and transmitting the measured temperature of the gas to the prediction device.

6. The combustion system according to claim 5,
wherein the processor is further configured to:
acquire the temperature of the gas; and
determine the threshold value based on a temperature tendency changing time and an extrapolated level for the threshold value, the temperature tendency changing time being a time when a tendency for the temperature of the gas changes and the extrapolated level for the threshold value being an extrapolated level of a time-dependent change in terms of a decrease in the level of the solid fuel when determining the threshold value.

7. The combustion system according to claim 6, wherein the processor is further configured to detect the temperature tendency changing time when the time-dependent change of the temperature of the gas changes from a constant state to an increasing state or a decreasing state.

8. The combustion system according to claim 6, wherein the processor is further configured to determine an extrapolated level for the threshold value at the temperature tendency changing time as the threshold value.

9. The combustion system according to claim 1, further comprising a concentration meter configured to measure a concentration of a chemical substance generated by combustion of the solid fuel and transmit the measured concentration of the chemical substance to the prediction device.

10. The combustion system according to claim 9,
wherein the processor is further configured to:
acquire the concentration of the chemical substance; and
determine the threshold value based on a concentration tendency changing time and an extrapolated level for the threshold value, the concentration tendency changing time being a time when a tendency for the concentration of the chemical substance changes and wherein the extrapolated level for the threshold value being an extrapolated level of a time-dependent change in terms of a decrease in the level of the solid fuel when determining the threshold value.

11. The combustion system according to claim 10, wherein the processor is further configured to detect the concentration tendency changing time when the time-dependent change of the concentration of the chemical substance changes from a constant state to an increasing state or a decreasing state.

12. The combustion system according to claim 10, wherein the processor is further configured to determine an extrapolated level for the threshold value at the concentration tendency changing time as the threshold value.

13. The combustion system according to claim 1, further comprising:
a thermometer configured to measure a temperature of gas supplied to the supply device, and transmit the measured temperature of the gas to the prediction device, and
a concentration meter configured to measure concentration of a chemical substance generated by combustion of the solid fuel and transmit the measured concentration of the chemical substance to the prediction device,
wherein the processor is further configured to:
acquire the temperature of the gas and the concentration of the chemical substance; and
determine the threshold value based on a temperature tendency changing time, a concentration tendency changing time and an extrapolated level for the threshold value, the temperature tendency changing time being a time when a tendency for the temperature of the gas changes, the concentration tendency changing time being a time when a tendency for the concentration of the chemical substance changes and the extrapolated level for the threshold value being an extrapolated level of a time-dependent change in terms of a decrease in the level of the solid fuel when determining the threshold value.

14. The combustion system according to claim 1, wherein the processor is further configured to display on the display device a latest adding time when the solid fuel was last added into the fuel storage.

15. The combustion system according to claim 1, wherein the processor is further configured to display the extrapolated level for the switching time on the display device.

16. The combustion system according to claim 1,
wherein the combustion system further comprises a plurality of units, each of the units comprising the fuel storage and the supply device, and
wherein the processor is further configured to:
acquire the level of the solid fuel of the each units; and
predict the switching time for each of the units.

17. A prediction device is configured to predict a switching time of a type of solid fuel supplied from a fuel storage to a combustion device via a supply device, the prediction device comprising:
an acquisition unit configured to acquire a level of solid fuel stored in the fuel storage;
a prediction unit configured to predict a future time as the switching time, the future time being a time when an extrapolated level for the switching time reaches a threshold value and the extrapolated level for the switching time being an extrapolated level of a time-dependent change in terms of a decrease in the level of the solid fuel when predicting the switching time; and
an output unit configured to display the switching time on a display device.
